(19) United States
(12) Patent Application Publication
(10) Pub. No.: US 2021/0115308 A1
(43) Pub. Date: Apr. 22, 2021

(54) PRESSURE-SENSITIVE ADHESIVE TAPE FOR WIRE HARNESS

(71) Applicant: NITTO DENKO CORPORATION, Ibaraki-shi (JP)

(72) Inventors: Shuhei Yamamoto, Osaka (JP); Akiko Takahashi, Osaka (JP)

(73) Assignee: NITTO DENKO CORPORATION, Ibaraki-shi (JP)

(21) Appl. No.: 17/008,943

(22) Filed: Sep. 1, 2020

(30) Foreign Application Priority Data
Oct. 18, 2019 (JP) 2019-190937

(51) Int. Cl. C09J 7/38; C09J 133/08

(52) U.S. Cl. CPC C09J 7/385; C09J 133/08; C09J 2423/106; C09J 2301/122; C09J 2301/302; C09J 2203/302

(57) ABSTRACT

A pressure-sensitive adhesive tape X of the present invention is a pressure-sensitive adhesive tape for a wire harness, for bundling or fixing a wire harness, and includes a substrate 10, and a pressure-sensitive adhesive layer 20 disposed at one side in a thickness direction of the substrate 10. The substrate 10 has a thickness of 85 μm or less. The pressure-sensitive adhesive layer 20 has a thickness of 55 μm or more.

### CROSS-REFERENCE TO RELATED APPLICATION

The present application claims priority from Japanese Patent Application No. 2019-190937 filed on Oct. 18, 2019, the contents of which are hereby incorporated by reference into this application.

### BACKGROUND OF THE INVENTION

### Field of the Invention

The present invention relates to a pressure-sensitive adhesive tape for a wire harness, the tape for use in bundling or fixing a wire harness.

### Description of Related Art

A pressure-sensitive adhesive tape may be used for bundling a wire harness, which is a bundle of cables such as electric wire cables and optical wire cables, or for fixing the wire harness to a predetermined portion. In bundling the wire harness with the pressure-sensitive adhesive tape, the pressure-sensitive adhesive tape is wound around the plurality of bundled cables. The pressure-sensitive adhesive tape for a wire harness is, for example, described in the following Patent Document 1.

### CITATION LIST

### Patent Document

Patent Document 1: Japanese Unexamined Patent Publication No. 2018-104499

### SUMMARY OF THE INVENTION

Bundling and fixing of the wire harness with the pressure-sensitive adhesive tape for a wire harness often continues a long period of time. Thus, the pressure-sensitive adhesive tape for a wire harness requires to be able to maintain a stable sticking state toward the wire harness over time.

Conventionally, however, in the pressure-sensitive adhesive tape wound around the wire harness, an end portion of the tape may lift to be peeled off after the lapse of time. The generation of the peeling is mainly attributed to a repulsive force generated in the pressure-sensitive adhesive tape that is in a state of being wound around the wire harness.

The present invention provides a pressure-sensitive adhesive tape for a wire harness, wire harness adhesive tape, suitable for achieving high sticking stability in bundling or fixing a wire harness.

The present invention [1] includes a pressure-sensitive adhesive tape for a wire harness, for bundling or fixing a wire harness, including a substrate having a thickness of 85 μm or less; and a pressure-sensitive adhesive layer disposed at one side in a thickness direction of the substrate, and having a thickness of 55 μm or more.

In the pressure-sensitive adhesive tape for a wire harness, the substrate has the thickness of 85 μm or less, and the pressure-sensitive adhesive layer has the thickness of 55 μm or more. This configuration is suitable for ensuring flexibility of the substrate and suppressing a repulsive force of the pressure-sensitive adhesive tape in a state of being wound around the wire harness, while ensuring a pressure-sensitive adhesive force of the pressure-sensitive adhesive layer to the wire harness. The wire harness adhesive tape with this configuration is therefore suitable for achieving high sticking stability in bundling or fixing the wire harness.

The present invention [2] includes the pressure-sensitive adhesive tape for a wire harness described in [1], wherein the substrate is a uniaxially stretched film.

This configuration is advantageous for achieving excellent hand-cutting properties in the pressure-sensitive adhesive tape for a wire harness.

The present invention [3] includes the pressure-sensitive adhesive tape for a wire harness described in [1] or [2], wherein a ratio of the thickness of the pressure-sensitive adhesive layer to the thickness of the substrate is 80% or more.

This configuration is preferable in achieving high sticking stability in bundling or fixing the wire harness with the pressure-sensitive adhesive tape for a wire harness.

### BRIEF DESCRIPTION OF THE DRAWINGS

FIG. 1 shows a cross-sectional schematic view of a wire harness adhesive tape according to one embodiment of the present invention.

### DETAILED DESCRIPTION OF THE INVENTION

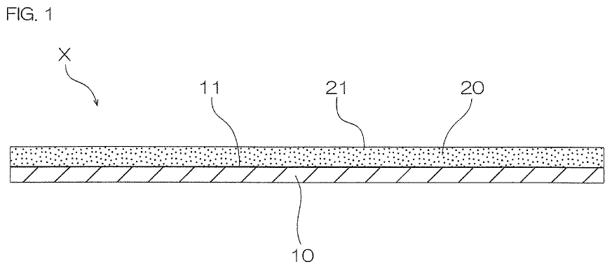

FIG. 1 shows a cross-sectional schematic view of a pressure-sensitive adhesive tape X according to one embodiment of the present invention. The pressure-sensitive adhesive tape X is a pressure-sensitive adhesive tape for a wire harness for bundling a wire harness or fixing a wire harness to a predetermined portion. The pressure-sensitive adhesive tape X includes a substrate 10 and a pressure-sensitive adhesive layer 20. The substrate 10 has a sheet shape having a predetermined thickness. The pressure-sensitive adhesive layer 20 is disposed at one side in a thickness direction of the substrate 10, and preferably disposed so as to be in contact with a one-side surface in the thickness direction of the substrate 10.

The substrate 10 is a component that functions as a support in the pressure-sensitive adhesive tape X. The substrate 10 is, for example, a plastic film having flexibility. Examples of a material for the plastic film include polyolefin, polyester, polyamide, polyimide, polyvinyl chloride, polyvinylidene chloride, cellulose, polystyrene, and polycarbonate. Examples of the polyolefin include polyethylene, polypropylene, poly-1-butene, poly-4-methyl-1-pentene, ethylene-propylene copolymer, ethylene-1-butene copolymer, ethylene-vinyl acetate copolymer, ethylene-ethyl acrylate copolymer, and ethylene-vinyl alcohol copolymer. Examples of the polyester include polyethylene terephthalate, polyethylene naphthalate, and polybutylene terephthalate. Examples of the polyamide include nylon 6; nylon 6,6; and partially aromatic polyamide. The substrate 10 may be composed of one, or two or more materials. The substrate 10 may have a single-layer structure or a multi-layer structure. From the viewpoint of achieving both flexibility and mechanical strength in the substrate 10, the plastic material for the substrate 10 is preferably polyolefin, more preferably polypropylene.

The substrate 10 has a surface 11 facing the pressure-sensitive adhesive layer 20. The surface 11 may be subjected to physical treatment, chemical treatment, or undercoating treatment for improving adhesive properties with the pressure-sensitive adhesive layer 20. Examples of the physical treatment include corona treatment and plasma treatment. Examples of the chemical treatment include acid treatment and alkali treatment.

The substrate 10 has a thickness of preferably 55 μm or more, and more preferably 60 μm or more. This is preferred from the viewpoint of strength of the substrate 10 during the use of the pressure-sensitive adhesive tape, and also from the viewpoint of preventing thermal deformation of the substrate 10 at the time of application of a pressure-sensitive adhesive composition in a step of forming the pressure-sensitive adhesive layer on the substrate 10. The substrate 10 has a thickness of 85 μm or less, and preferably 80 μm or less. This configuration is suitable for ensuring flexibility of the substrate 10 and suppressing a repulsive force of the pressure-sensitive adhesive tape X in a state of being wound around a wire harness.

The substrate 10 is preferably a uniaxially stretched film. The uniaxially stretched film is defined as a film that undergoes to a uniaxially stretching treatment of a film-shaped extrusion molded article after extruding and molding a material resin in a production process of a film. A stretching ratio of the uniaxially stretched film is, for example, 2.5 times or more, and preferably 3 times or more; and for example, 6 times or less, and preferably 5.5 times or less. The configuration in which the substrate 10 is the uniaxially stretched film is suitable for achieving excellent hand-cutting properties in the pressure-sensitive adhesive tape X.

From the viewpoint of achieving both the excellent hand-cutting properties in the pressure-sensitive adhesive tape X and the above-described prevention of the thermal deformation of the substrate 10, the substrate 10 is preferably a uniaxially stretched polypropylene film.

The pressure-sensitive adhesive layer 20 is a component for attaching the pressure-sensitive adhesive tape X to an adherend, and has a pressure-sensitive adhesive surface 21 at the side opposite to the substrate 10. The pressure-sensitive adhesive layer 20 is a layer formed from a pressure-sensitive adhesive composition containing a base polymer.

The base polymer is a pressure-sensitive adhesive component for developing pressure-sensitive adhesive properties in the pressure-sensitive adhesive layer 20. Examples of the base polymer include polymers showing rubber elasticity in a room temperature region, such as acrylic polymer, rubber polymer, polyester polymer, urethane polymer, polyether polymer, silicone polymer, polyamide polymer, and fluorine polymer. An acrylic polymer is preferably used as the base polymer from the viewpoint of ensuring the pressure-sensitive adhesive properties in the pressure-sensitive adhesive layer 20.

The content of the base polymer in the pressure-sensitive adhesive layer 20 is preferably 50 mass % or more, more preferably 60 mass % or more, and further more preferably 70 mass % or more from the viewpoint of proper development of a function of the base polymer in the pressure-sensitive adhesive layer 20.

The acrylic polymer is, for example, a polymer obtained by polymerizing monomer components containing an alkyl (meth)acrylate at a ratio of 50 mass % or more. The “(meth)acrylate” represents acrylate and/or methacrylate.

An example of the alkyl (meth)acrylate includes an alkyl (meth)acrylate containing a straight-chain or branched alkyl group having 1 to 20 carbon atoms. Examples thereof include methyl (meth)acrylate, ethyl (meth)acrylate, propyl (meth)acrylate, n-butyl (meth)acrylate, isopropyl (meth)acrylate, isobutyl (meth)acrylate, s-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, isotridecyl (meth)acrylate, tetradecyl (meth)acrylate, isotetradecyl (meth)acrylate, pentadecyl (meth)acrylate, hexadecyl (meth)acrylate, heptadecyl (meth)acrylate, octadecyl (meth)acrylate, isooctadecyl (meth)acrylate, nonadecyl (meth)acrylate, and eicosyl (meth)acrylate. These alkyl (meth)acrylates may be used alone or in combination of two or more. As the alkyl (meth)acrylate, an alkyl acrylate containing an alkyl group having 1 to 12 carbon atoms is preferably used, and each of methyl acrylate and 2-ethylhexyl acrylate is more preferably used.

In view of appropriate development of basic properties such as pressure-sensitive adhesive properties in the pressure-sensitive adhesive layer 20, a ratio of the alkyl (meth)acrylate in the monomer components is preferably 60 mass % or more, more preferably 70 mass % or more, further more preferably 80 mass % or more, particularly preferably 90 mass % or more, and especially preferably 95 mass % or more; and for example, 99.9 mass % or less.

The monomer components may contain one, or two or more functional group-containing vinyl monomers copolymerizable with the alkyl (meth)acrylate. The functional group-containing vinyl monomer is useful for improving the acrylic polymer in points such as introduction of crosslinking points to the acrylic polymer and ensuring a cohesive force of the acrylic polymer. From the viewpoint of ensuring the effect by using the functional group-containing vinyl monomer, a ratio of the functional group-containing vinyl monomer in the monomer component is preferably 0.1 mass % or more, more preferably 0.5 mass % or more, and further more preferably 1.5 mass % or more; and preferably 20 mass % or less, more preferably 10 mass % or less, further more preferably 5 mass % or less, and particularly preferably 3 mass % or less.

Examples of the functional group-containing vinyl monomer include carboxyl group-containing vinyl monomer, acid anhydride vinyl monomer, hydroxyl group-containing vinyl monomer, sulfo group-containing vinyl monomer, phosphate group-containing vinyl monomer, cyano group-containing vinyl monomer, and glycidyl group-containing vinyl monomer. These functional group-containing vinyl monomers may be used alone or in combination of two or more.

Examples of the carboxyl group-containing vinyl monomer include acrylate, methacrylate, 2-carboxyethyl (meth)acrylate, carboxypentyl (meth)acrylate, itaconate, maleate, fumarate, and crotonate. The monomer components contain preferably a carboxyl group-containing vinyl monomer, and more preferably an acrylate and/or a methacrylate.

Examples of the acid anhydride vinyl monomer include maleic anhydride and itaconic anhydride.

Examples of the hydroxyl group-containing vinyl monomer include 2-hydroxyethyl (meth)acrylate, 2-hydroxypropyl (meth)acrylate, 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)methyl (meth)acrylate.

Examples of the sulfo group-containing vinyl monomer include styrene sulfonic acid, allyl sulfonic acid, sodium vinylsulfonate, 2-(meth)acrylamide-2-methylpropane sulfonic acid, (meth)acrylamidepropane sulfonic acid, sulfopropyl (meth)acrylate, and (meth)acryloyloxynaphthalene sulfonic acid.

An example of the phosphate group-containing vinyl monomer includes 2-hydroxyethylacryloyl phosphate.

Examples of the cyano group-containing vinyl monomer include acrylonitrile and methacrylonitrile.

Examples of the glycidyl group-containing vinyl monomer include glycidyl (meth)acrylate and (meth)acrylic acid-2-ethylglycidyl ether.

The monomer components may contain another copolymerizable monomer that is copolymerizable with the alkyl (meth)acrylate. Examples of the monomer include vinyl monomers such as vinyl acetate, vinyl propionate, styrene, α-methylstyrene, N-vinylcaprolactam, and N-vinylpyrrolidone; tetrahydrofurfuryl (meth)acrylate, fluorine (meth)acrylate, silicone (meth)acrylate, 2-methoxyethyl acrylate, and N-acryloylmorpholine.

The acrylic polymer can be formed by polymerizing the above-described monomer components. Examples of a polymerization method include emulsion polymerization, solution polymerization, and bulk polymerization. Preferably, emulsion polymerization is used. In the emulsion polymerization, for example, first, a mixture containing monomer components necessary for forming the acrylic polymer, an emulsifier, and water is stirred, thereby preparing a monomer emulsion. Next, a polymerization initiator is added to the monomer emulsion to initiate a polymerization reaction. A chain transfer agent may be also used to adjust a molecular weight of the acrylic polymer in the polymerization reaction. The polymerization method may be a dropping polymerization or a collective polymerization. The polymerization time is, for example, 0.5 to 10 hours. A polymerization temperature is, for example, 50° C. to 80° C.

Examples of the emulsifier include anionic emulsifiers such as sodium polyoxyethylene lauryl sulfate, sodium lauryl sulfate, ammonium lauryl sulfate, sodium dodecylbenzenesulfonate, sodium polyoxyethylene alkyl ether sulfate, ammonium polyoxyethylene alkyl phenyl ether sulfate, sodium polyoxyethylene alkyl phenyl ether sulfate, and sodium polyoxyethylene alkyl sulfosuccinate. Examples of the emulsifier also include nonionic emulsifiers such as polyoxyethylene alkyl ether, polyoxyethylene alkyl phenyl ether, polyoxyethylene fatty acid ester, and polyoxyethylene polyoxypropylene block polymer. Examples of the emulsifier also include radical polymerizable (reactive) emulsifiers obtained by introducing a radical polymerizable functional group such as vinyl group, propenyl group, isopropenyl group, vinyl ether group, and allyl ether group to the anionic emulsifier and the nonionic emulsifier. These emulsifiers may be used alone or in combination of two or more. A mixing amount of the emulsifier with respect to 100 parts by mass of the monomer components is, for example, 0.2 to 10 parts by mass.

Examples of the polymerization initiator include azo polymerization initiator, peroxide polymerization initiator, and redox polymerization initiator obtained by using peroxide and a reducing agent in combination. Examples of the azo polymerization initiator include 2,2′-azobisisobutyronitrile, 2,2′-azobis(2-amidinopropane) dihydrochloride, 2,2′-azobis [2-(5-methyl-2-imidazoline-2-yl)propane] dihydrochloride, and 2,2′-azobis(N,N′-dimethyleneisobutylamidine). Examples of the peroxide polymerization initiator include benzoyl peroxide, t-butyl hydroperoxide, and hydrogen peroxide. Examples of the redox polymerization initiator include combination of hydrogen peroxide water and ascorbic acid, combination of hydrogen peroxide water and iron(II) salt, and combination of persulfate and sodium hydrogensulfite. These polymerization initiators may be used alone or in combination of two or more. A mixing amount of the polymerization initiator with respect to 100 parts by mass of the monomer components is, for example, 0.01 to 2 parts by mass.

Examples of the chain transfer agent include t-laurylmercaptan, glycidylmercaptan, mercaptoacetic acid, 2-mercaptoethanol, thioglycolic acid, 2-ethylhexyl thioglycolate, and 2,3-dimercapto-1-propanol. These chain transfer agents may be used alone or in combination of two or more. A mixing amount of the chain transfer agent with respect to 100 parts by mass of the monomer components is, for example, 0.001 to 0.5 parts by mass.

A weight average molecular weight of the acrylic polymer thus formed is, for example, 100000 or more, and preferably 300000 or more; and for example, 5000000 or less, and preferably 3000000 or less. The weight average molecular weight of the acrylic polymer is measured by gel permeation chromatograph (GPC) with polystyrene calibration.

The pressure-sensitive adhesive composition may contain other components in addition to the base polymer. Examples of the other components include tackifier, silane coupling agent, thickener, cross-linking agent, filler, oxidation inhibitor, surfactant, and antistatic agent.

Examples of the tackifier include various tackifier resins such as rosin resin, rosin derivative resin, petroleum resin, terpene resin, phenol resin, and ketone resin. A mixing amount of the tackifier with respect to 100 parts by mass of the base polymer is, for example, 5 to 40 parts by mass.

Examples of the silane coupling agent include 3-methacryloxypropyltrimethoxysilane, 3-methacryloxypropylmethyldimethoxysilane, 3-methacryloxypropylmethyldiethoxysane, and 3-methacryloxypropyltriethoxysilane. A mixing amount of the silane coupling agent with respect to 100 parts by mass of the base polymer is, for example, 0.005 to 1 parts by mass.

Examples of the thickener include polyacrylic acid thickener, urethane thickener, and polyvinyl alcohol thickener. A mixing amount of the thickener with respect to 100 parts by mass of the base polymer is, for example, 0.1 to 10 parts by mass.

The pressure-sensitive adhesive composition may also contain an acid or a base (ammonia water or the like) used for adjusting a pH as needed.

The viscosity of the pressure-sensitive adhesive composition is preferably 5 to 20 Pa·s, and more preferably 7 to 15 Pa·s. The viscosity is defined as a value measured by using a B-type viscometer under the conditions of rotor No. 5, number of rotor rotations of 20 rpm, liquid temperature of 30° C., and measurement time of one minute.

The pressure-sensitive adhesive tape X can be, for example, produced by applying the pressure-sensitive adhesive composition onto the substrate 10 to form a coating film, and thereafter, drying the coating film to form the pressure-sensitive adhesive layer 20.

The pressure-sensitive adhesive layer 20 has a thickness of 55 μm or more, preferably 60 μm or more, more preferably 70 μm or more, and further more preferably 80 μm or more from the viewpoint of ensuring the sufficient pressure-sensitive adhesive force with respect to the wire harness as an adherend. The pressure-sensitive adhesive layer 20 has a thickness of preferably 100 μm or less, more preferably 95 μm or less, and further more preferably 90 μm or less from the viewpoint of achieving light weight of the pressure-sensitive adhesive tape X, and also from the viewpoint of reducing an amount of heat required for drying the pressure-sensitive adhesive composition applied onto the substrate 10 and prevent or suppress the deformation of the substrate 10.

A ratio of the thickness of the above-described pressure-sensitive adhesive layer 20 with respect to the thickness of the substrate 10 is 80% or more, preferably 90% or more, more preferably 100% or more, and further more preferably 110% or more and, for example, 150% or less, and preferably 130% or less. This configuration is preferable to achieve high sticking stability in bundling or fixing the wire harness with the pressure-sensitive adhesive tape X.

After attached to a stainless steel board, the pressure-sensitive adhesive tape X shows a pressure-sensitive adhesive force with respect to the stainless steel board in a peeling test, under the conditions of 23° C., peeling angle of 180°, and peeling rate, of 300 mm/min is, for example, 10 N/20 mm or more, preferably 12 N/20 mm or more, more preferably 14 N/20 mm or more, and further more preferably 16 N/20 mm or more. This configuration is preferable for the tape X to exhibit an excellent pressure-sensitive adhesive force with respect to the wire harness.

As described above, in the pressure-sensitive adhesive tape X, the substrate 10 has a thickness of 85 μm or less, and preferably 80 μm or less; and the pressure-sensitive adhesive layer 20 has a thickness of 55 μm or more, and preferably 60 μm or more. This configuration is suitable for ensuring flexibility of the substrate 10 to suppress a repulsive force of the pressure-sensitive adhesive tape X in a state of being wound around the wire harness, while ensuring the pressure-sensitive adhesive force of the pressure-sensitive adhesive layer 20 with respect to the wire harness. The pressure-sensitive adhesive tape X with this configuration is therefore suitable for achieving high sticking stability in bundling or fixing the wire harness.

As described above, the substrate 10 of the pressure-sensitive adhesive tape X is preferably a uniaxially stretched film. When the substrate 10 of the pressure-sensitive adhesive tape X is the uniaxially stretched film, excellent hand-cutting properties can be easily achieved in the pressure-sensitive adhesive tape X. The pressure-sensitive adhesive tape X with the substrate 10 of uniaxially stretched is suitable for achieving the excellent hand-cutting properties, for example, compared to the tape X with the substrate 10 of biaxially stretched. The more excellent the hand-cutting properties of the pressure-sensitive adhesive tape X is, higher work efficiency can be achieved, for example, in a workplace where the wire harness is fixed to many portions with many pieces of pressure-sensitive adhesive tapes X.

Additionally, the configuration in which the substrate 10 is the uniaxially stretched film is more preferable than a structure in which the substrate 10 is a non-stretched film from the viewpoint of preventing the thermal deformation of the substrate 10 at the time of application of the pressure-sensitive adhesive composition in a step of forming the pressure-sensitive adhesive layer on the substrate 10.

### EXAMPLES

### Example 1

Preparation of Acrylic Polymer Emulsion

A mixture was stirred in a vessel with a homomixer, thereby preparing a monomer emulsion solution. The mixture contained 85 parts by mass of 2-ethylhexyl acrylate (2EHA), 13 parts by mass of methyl methacrylate (MA), 1.25 parts by mass of acrylate (AA), 0.75 parts by mass of methacrylate (MAA), 0.048 parts by mass of t-laurylmercaptan as a chain transfer agent, 0.02 parts by mass of 3-methacryloxypropyltrimethoxysilane (trade name: “KBM-503”, manufactured by Shin-Etsu Chemical Co., Ltd.) as a silane coupling agent, 2 parts by mass of sodium polyoxyethylene lauryl sulfate as an emulsifier, and 30 parts by mass of ion exchanged water. Meanwhile, in a reaction vessel equipped with a reflux condenser, a nitrogen gas introducing pipe, a thermometer, and a stirrer, 60 parts by mass of ion exchanged water was stirred at 60° C. for one hour or more, while a nitrogen gas was introduced thereto. Next, after the reaction vessel was charged with 0.1 parts by mass of 2,2′-azobis [2-(5-methyl-2-imidazoline-2-yl)propane] dihydrochloride (trade name: “VA-057”, manufactured by Wako Pure Chemical Industries, Ltd.) as a polymerization initiator, the above-described monomer emulsion was gradually added thereto dropwise over four hours to progress an emulsion polymerization reaction (reaction temperature was retained at 60° C.). After the completion of dropping of the monomer emulsion, the obtained reaction liquid was further retained at 60° C. for three hours. Thereafter, 0.1 parts by mass of 10% by mass hydrogen peroxide water and 0.2 parts by mass of ascorbic acid were added to the reaction liquid. Then, the reaction liquid was cooled to normal temperature, and thereafter, a pH of the reaction liquid was adjusted to 7.0 by adding 10% by mass of ammonia water. In this manner, an acrylic polymer emulsion was prepared.

Preparation of Pressure-Sensitive Adhesive Composition

The acrylic polymer emulsion and an aqueous emulsion of polymerized rosin ester (trade name: “E-865NT”, manufactured by Arakawa Chemical Industries, Ltd.) as a tackifier were mixed at an amount ratio of 10 parts by mass of the tackifier (solid content) to 100 parts by mass of the acrylic polymer in the acrylic polymer emulsion, thereby obtaining a composition. By using 10% by mass of ammonia water as a pH adjuster and polyacrylate (trade name: “Aron B-500”, manufactured by Toagosei Co., Ltd.) as a thickener, the composition was adjusted to have a pH of 8.0 and the viscosity of 10 Pa·s (the viscosity was a value measured by using a B-type viscometer under the conditions of rotor No. 5, number of rotor rotations of 20 rpm, liquid temperature of 30° C., and measurement time of one minute). In this manner, a pressure-sensitive adhesive composition was prepared.

Production of Pressure-Sensitive Adhesive Tape

A uniaxially stretched polypropylene film (trade name: “PYLEN OT (uniaxially stretched type)”, thickness of 70 μm, manufactured by TOYOBO CO., LTD.) was subjected to release treatment (treatment name: “BK1”) provided by Fujiko Co., Ltd., thereby obtaining a one-surface release-treated substrate. Next, the above-described pressure-sensitive adhesive composition was applied onto a non-release-treated surface of the substrate, thereby forming a coating film. Next, the coating film was dried at 100° C. for two minutes, so that a pressure-sensitive adhesive layer having a thickness of 70 μm was formed on the substrate. In this manner, a pressure-sensitive adhesive tape of Example 1 was produced.

### Examples 2 and 3, and Comparative Example 1

Each pressure-sensitive adhesive tape of Examples 2 and 3, and Comparative Example 1 was produced in the same manner as the pressure-sensitive adhesive tape of Example 1, except that a uniaxially stretched polypropylene film (trade name: “PYLEN OT (uniaxially stretched type)”) having a thickness of 60 μm (Example 2), 80 μm (Example 3), or 90 μm (Comparative Example 1) was used instead of the uniaxially stretched polypropylene film having a thickness of 70 μm.

### Examples 4 and 5

Each pressure-sensitive adhesive tape of Examples 4 and 5 was produced in the same manner as the pressure-sensitive adhesive tape of Example 1, except that the thickness of the pressure-sensitive adhesive layer was changed to 60 μm (Example 4) or 90 μm (Example 5) instead of the thickness of 70 μm.

### Example 6

A pressure-sensitive adhesive tape of Example 6 was produced in the same manner as the pressure-sensitive adhesive tape of Example 1, except that a biaxially stretched polypropylene film (trade name: “PYLEN OT (biaxially stretched type)”, thickness of 70 μm, manufactured by TOYOBO CO., LTD.) was used instead of the uniaxially stretched polypropylene film (trade name: “PYLEN OT”, thickness of 70 μm, manufactured by TOYOBO CO., LTD.).

### Comparative Example 2

A pressure-sensitive adhesive tape of Comparative Example 2 was produced in the same manner as the pressure-sensitive adhesive tape of Example 1, except that the thickness of the pressure-sensitive adhesive layer was changed to 30 μm instead of the thickness of 70 μm.

Repulsion Resistance

Repulsion resistance of each pressure-sensitive adhesive tape of Examples and Comparative Examples after attachment of an adherend was examined. First, a test piece (width 20 mm x length 35 mm) was cut out from the pressure-sensitive adhesive tape. Next, the test piece of the pressure-sensitive adhesive tape was wound around a cylindrical release film (outer size of 12 mm). The cylindrical release film was obtained by winding up a release liner (trade name: “DIAFOIL MRF38”, manufactured by Mitsubishi Chemical Corporation) with a release-treated surface thereof facing outwardly to obtain a cylindrical shape having an outer size of 12 mm. The test piece was wound around the cylindrical release film so that a lengthwise direction of the test piece was along a peripheral direction of the cylindrical release film. After the test piece of the pressure-sensitive adhesive tape wound around the cylindrical release film was left to stand at normal temperature for 24 hours, a peeling length (mm) of the test piece was measured when an end portion of the test piece of the pressure-sensitive adhesive tape lifted to be peeled off. The results are shown in Table 1. As the repulsive force generated in the pressure-sensitive adhesive tape in a state where the pressure-sensitive adhesive tape was wound around the above-described cylindrical release film was stronger, peeling of the end portion of the pressure-sensitive adhesive tape was more easily generated, and the peeling length was longer.

Pressure-Sensitive Adhesive Force

A pressure-sensitive adhesive force of a pressure-sensitive adhesive layer of each pressure-sensitive adhesive tape of Examples and Comparative Examples was examined as follows. First, a test piece (width 20 mm×length 100 mm) was cut out from the pressure-sensitive adhesive tape. Next, the test piece of the pressure-sensitive adhesive tape was attached to an SUS board to be compressively bonded thereto by a compression-bonding operation of one reciprocation of a 2-kg roller. Next, after the test piece of the pressure-sensitive adhesive tape was left to stand at 25° C. for 30 minutes, the pressure-sensitive adhesive force (N/20 mm) thereof with respect to the SUS board was measured by using a tensile testing machine (trade name: “AUTOGRAPH”, manufactured by Shimadzu Corporation). In the measurement, a measurement temperature was 25° C., a peeling angle made between the test piece and the SUS board was 180°, and a tensile rate of the test piece was 300 mm/min. The results are shown in Table 1.

Hand-Cutting Properties

Hand-cutting properties of each pressure-sensitive adhesive tape of Examples and Comparative Examples were examined. To be specific, the pressure-sensitive adhesive tape was manually attempted to be cut. In a case where the cutting succeeded, the hand-cutting properties were evaluated as “cuttable”, and in a case where the cutting failed, the hand-cutting properties were evaluated as “uncuttable”. The results are shown in Table 1.

Evaluation

The pressure-sensitive adhesive tape of Comparative Example 1, whose substrate has a thickness of above 85 μm, had low repulsion resistance due to a very strong repulsive force of the substrate in a state of being wound around the above-described cylindrical release film, thereby generating peeling of 2 mm. The pressure-sensitive adhesive tape of Comparative Example 2, whose pressure-sensitive adhesive layer has a thickness of below 55 μm, had low repulsion resistance due to a very weak pressure-sensitive adhesive force of the pressure-sensitive adhesive layer in a state of being wound around the above-described cylindrical release film, thereby generating peeling of 1 mm. In contrast, each pressure-sensitive adhesive tape of Examples 1 to 6, in which the substrate has a thickness of 85 μm or less and the pressure-sensitive adhesive layer has a thickness of 55 μm or more, generated no peeling (that is, a peeling length of 0 mm) in a state of being wound around the above-described cylindrical release film, thereby showing the excellent repulsion resistance. Additionally, each pressure-sensitive adhesive tape of Examples 1 to 5, whose substrate is the uniaxially stretched film, showed the hand-cutting properties.

TABLE 1

| | | | | | | | Comparative | Comparative |
|---|---|---|---|---|---|---|---|---|
| | Ex. 1 | Ex. 2 | Ex. 3 | Ex. 4 | Ex. 5 | Ex. 6 | Ex. 1 | Ex. 2 |
| Thickness of Substrate (μm) | 70 | 60 | 80 | 70 | 70 | 70 | 90 | 70 |
| Type of Stretching of | Uniaxially | Uniaxially | Uniaxially | Uniaxially | Uniaxially | Biaxially | Uniaxially | Uniaxially |
| Substrate | Stretched | Stretched | Stretched | Stretched | Stretched | Stretched | Stretched | Stretched |
| Thickness of Pressure-Sensitive | 70 | 70 | 70 | 60 | 90 | 70 | 70 | 30 |
| Adhesive Layer (μm) | | | | | | | | |
| Peeling Length (mm) | 0 | 0 | 0 | 0 | 0 | 0 | 2 | 1 |
| Pressure-Sensitive Adhesive | 15 | 15 | 16 | 14 | 18 | 15 | 17 | 7 |
| Force (N/20 mm) | | | | | | | | |
| Hand-Cutting Properties | Cuttable | Cuttable | Cuttable | Cuttable | Cuttable | Uncuttable | Cuttable | Cuttable |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A pressure-sensitive adhesive tape for a wire harness, for bundling or fixing a wire harness, comprising:
a substrate having a thickness of 85 μm or less; and
a pressure-sensitive adhesive layer disposed at one side in a thickness direction of the substrate, and having a thickness of 55 μm or more.

2. The pressure-sensitive adhesive tape for a wire harness according to claim 1, wherein
the substrate is a uniaxially stretched film.

3. The pressure-sensitive adhesive tape for a wire harness according to claim 1, wherein
a ratio of the thickness of the pressure-sensitive adhesive layer to the thickness of the substrate is 80% or more.
